(19) United States
(12) Patent Application Publication
(10) Pub. No.: US 2025/0155086 A1
(43) Pub. Date: May 15, 2025

(54) HYDROGEN STORAGE AND SUPPLY DEVICE AND CORRESPONDING ASSEMBLY

(71) Applicant: Faurecia Hydrogen Solutions France, NANTERRE (FR)

(72) Inventors: Frédéric GREBER, ECOT (FR); Yannick FOURCAUDOT, LUZE (FR)

(21) Appl. No.: 18/719,951

(22) PCT Filed: Dec. 22, 2022
(86) PCT No.: PCT/EP2022/087457

§ 371 Date: Jun. 14, 2024

(30) Foreign Application Priority Data
Dec. 22, 2021 (FR) FR2114228

(51) Int. Cl. F17C 7/02; H01M 8/04007; H01M 8/04082

(52) U.S. Cl. CPC F17C 7/02; H01M 8/04037; H01M 8/04201; F17C 2201/0109; F17C 2203/0391; F17C 2221/012; F17C 2223/0153; F17C 2227/0355; F17C 2265/06; F17C 2270/0168; F17C 2270/0184

(57) ABSTRACT

A hydrogen storage and supply device comprises an internal reservoir which internally delimits a storage volume and an external reservoir, wherein an intermediate space separates the internal reservoir from the external reservoir. A heat exchanger has a hydrogen circulation side provided with a hydrogen inlet; and a conduit supplies the heat exchanger with hydrogen. An external conduit is received in the intermediate space. The external conduit has: an intermediate volume; an upstream section having an upstream upper end passing through the internal reservoir and fluidically connected to the storage volume, and an upstream lower end connected to the intermediate volume; and a downstream section connected to the intermediate volume and having a downstream upper end connected to the hydrogen inlet. The downstream upper end is located at a first elevation, the upstream upper end is located at a second elevation, and the intermediate volume is located at a third elevation, lower than the first and second elevations.

### CROSS-REFERENCE TO RELATED APPLICATIONS

This application is the US national phase of PCT/EP2022/087457, which was filed on Dec. 22, 2022 claiming the benefit of French Application No. 21 14228, filed on Dec. 22, 2021, which is incorporated herein by reference in its entirety.

### TECHNICAL FIELD

The disclosure generally relates to a device for storing and supplying hydrogen, in particular for the purpose of supplying a fuel cell.

This hydrogen storage and supply device, in addition to the present application, is protected by the following applications, filed the same day, by the same applicant, and relating to the following aspects:
an application relating to a storage and hydrogen supply device comprising a method or mechanism for heating the cryogenic fluid leaving the interior reservoir, before supplying a heat exchanger, this means being an alternative to that of the present application; this application bears the internal reference FR2114229;
an application relating to a storage unit of a cryogenic fluid comprising a gas absorber or getter, the replacement of which is facilitated; this application bears the internal reference FR2114209;
an application on a unit for storing a cryogenic fluid comprising a metal suspension from the internal reservoir to the external reservoir; this application bears the internal reference FR2114255;
an application for an assembly comprising a cryogenic fluid storage unit and a cryogenic valve; this application bears the internal reference FR2114242;
an application relating to a unit for storing a cryogenic fluid comprising at least one additional reservoir for extending the dormancy time, this application bears the internal reference FR2114234.

BACKGROUND Internal combustion engines are gradually replaced by electric motors for the propulsion of vehicles, in particular motor vehicles such as individual cars, utility vehicles or trucks, or for propulsion of trains, boats, etc.

One solution for electrically powering such motors consists in carrying a fuel cell on board the vehicle. This fuel cell is supplied by an anodic gas which is typically dihydrogen, commonly called hydrogen, and by a cathode gas which is for example dioxygen contained in the air, commonly called air oxygen or oxygen.

The hydrogen must be stored on board the vehicle in the most compact form possible, so as to reduce costs and optimize the use of the space on board the vehicle.

One possibility for reducing the volume occupied by the hydrogen reserve is to store the hydrogen at very low temperature, in liquid form.

The hydrogen is liquid, at ambient pressure, at a temperature close to 20 K.

No element containing liquid hydrogen must be in direct contact with the ambient air, because this would cause liquefaction of the air. Indeed, air liquefies from −196° C., that is, around 77 K. The liquid air can contain under certain conditions up to 50% oxygen by mass, the liquid air thus being extremely oxidizing. It is therefore imperative that the system for supplying hydrogen to the fuel cell from the liquid hydrogen storage device does not have any wall in contact with air at a temperature below −196° C.

The fuel cell operates with gaseous hydrogen, at a temperature above −40° C.

There is therefore a need for a hydrogen storage and supply device, provided for the storage of hydrogen in liquid form and for the supply of an electricity production member, such as a fuel cell, from the storage of hydrogen in liquid form, which makes it possible to guarantee an absence of liquefaction of the ambient air in contact with the circuits containing hydrogen.

### SUMMARY

To this end, the disclosure relates to a device for storing and supplying hydrogen, comprising:
an internal reservoir which internally delimits a storage volume intended to store liquid hydrogen;
an external reservoir inside which the internal reservoir is arranged, wherein an intermediate space separates the internal reservoir from the external reservoir;
thermal insulation interposed between the internal reservoir and the external reservoir;
a heat exchanger, comprising a hydrogen circulation side provided with a hydrogen inlet and a hydrogen outlet, and a circulation side of a heat transfer fluid;
a conduit for supplying the heat exchanger with hydrogen, comprising an external conduit housed in the intermediate space, the external conduit having:
an intermediate volume;
an upstream section having an upstream upper end passing through the internal reservoir and fluidically connected to the storage volume, and an upstream lower end connected to the intermediate volume;
a downstream section connected to the intermediate volume and having a downstream upper end connected to the hydrogen inlet;
the downstream upper end being located at a first elevation, the upstream upper end being located at a second elevation, the intermediate volume being located at a third elevation, lower than the first and second elevations.

The liquid hydrogen storage device, comprising an internal reservoir, an external reservoir and an intermediate thermal insulation, allows excellent thermal insulation for the liquid hydrogen stored in the storage volume of the internal reservoir. The ambient air is never in direct contact with the wall of the internal reservoir, due to the presence of the external reservoir and the thermal insulation existing between the internal reservoir and the external reservoir.

The heat exchanger makes it possible to heat the liquid hydrogen stored in the internal reservoir, and to carry this hydrogen to a temperature compatible with the operation of an electricity-producing member such as a fuel cell.

The hydrogen circulates from the storage volume to the inlet of the heat exchanger in the supply conduit. The part of this supply conduit located outside the internal reservoir is placed between the internal reservoir and the external reservoir, without direct contact with the external reservoir. Therefore, there is no possible direct contact between the ambient air and the external conduit.

Furthermore, the external conduit is heated by radiation from the external reservoir. This helps to ensure that the droplets of liquid hydrogen, which could be driven outside the storage volume with the gaseous hydrogen and which circulate in the external conduit, are evaporated before reaching the inlet of the heat exchanger.

The external conduit is arranged in a V, the intermediate volume constituting the low point, the complementary fastening member and the upstream upper end constituting the high points. Thus, the liquid hydrogen driven by the gaseous hydrogen does not circulate directly toward the heat exchanger, but tends to accumulate at the low point, where it is evaporated due to heating by thermal radiation.

The device may furthermore have one or more of the following features, considered alone or according to any technically possible combination:
the heat exchanger comprises a fastening member around the hydrogen inlet, the storage and supply device comprising a complementary fastening member integral with the external reservoir and attached to the fastening member;
the complementary fastening member is located close to an apex of the external reservoir;
the intermediate volume is a liquid-gas separator;
the intermediate volume comprises a lower part for collecting the liquid and an upper part to which the upstream section and the downstream section are connected, the lower part preferably having a volume greater than the upper part;
the internal reservoir comprises a cylindrical shroud with a horizontal axis and two bottoms closing two axial ends of the cylindrical shroud, the external conduit being arranged opposite one of the bottoms;
the supply conduit comprises an internal conduit, housed in a headspace of the storage volume, and having orifices opening into the storage volume, the upstream upper end of the upstream section being fluidically connected to the internal conduit;
a difference between the second elevation and the third elevation is greater than 150 mm;
the hydrogen circulation side comprises a plurality of hydrogen circulation tubes and a hydrogen distribution collector in the tubes into which the hydrogen inlet opens, the heat transfer fluid circulation side comprising a double jacket insulating the hydrogen distribution collector from an external atmosphere.

According to a second aspect, the disclosure relates to an assembly:
a fuel cell having an anode gas circuit provided with an anode gas inlet and a cell cooling circuit having a cooling inlet and a cooling outlet;
a hydrogen storage and supply device according to any of the preceding claims, the hydrogen outlet on the hydrogen circulation side of the heat exchanger being fluidically connected to the anode gas inlet;
a heat transfer fluid circuit comprising:
an expansion vessel having a vessel outlet and a vessel inlet fluidically connected to the cooling outlet,
a heat transfer fluid circulation member having a suction fluidically connected to the vessel outlet, and a discharge fluidically connected to a heat transfer fluid inlet on the heat transfer fluid circulation side of the heat exchanger, and
an orientation member having an inlet fluidically connected to a heat transfer fluid outlet on the heat transfer fluid circulation side of the heat exchanger, a first outlet fluidically connected to the vessel inlet and a second outlet fluidically connected to the cooling inlet of the cell cooling circuit, the orientation member being configured to fluidically connect the inlet selectively to the first outlet or the second outlet.

This assembly may also have the following feature:
the heat exchanger comprises an electrical heating element arranged to electrically heat the hydrogen, the assembly comprising a controller configured to selectively:
   turn on the electrical heating member and fluidically connect the inlet of the orientation member to the first outlet; or
   turn off the electrical heating member and fluidically connect the inlet of the directing member to the second outlet.

### BRIEF DESCRIPTION OF THE DRAWINGS

Other features and advantages of the disclosure will become apparent from the detailed description given hereunder, by way of non-limiting indication, referring to the appended figures, among which:

FIG. 1 is a schematic representation of an assembly according to the disclosure, comprising a fuel cell supplied with hydrogen by a storage and supply device, and a heat transfer fluid circuit;

FIG. 2 is a front view of the storage and supply device of FIG. 1, the bottom of the external reservoir not being shown, in order to reveal the outer part of the conduit for supplying the heat exchanger with hydrogen;

FIG. 3 is a perspective view showing the bottom of the internal reservoir and the inner part of the conduit for supplying the heat exchanger with hydrogen of FIG. 2;

FIG. 4 is a perspective view of the conduit for supplying the heat exchanger with hydrogen of FIGS. 2 and 3;

FIG. 5 is a sectional view of the heat exchanger of FIGS. 1 and 2, taken along the central axis of the heat exchanger; and

FIG. 6 is a perspective view of the bundle of tubes of the heat exchanger of FIG. 5.

### DETAILED DESCRIPTION

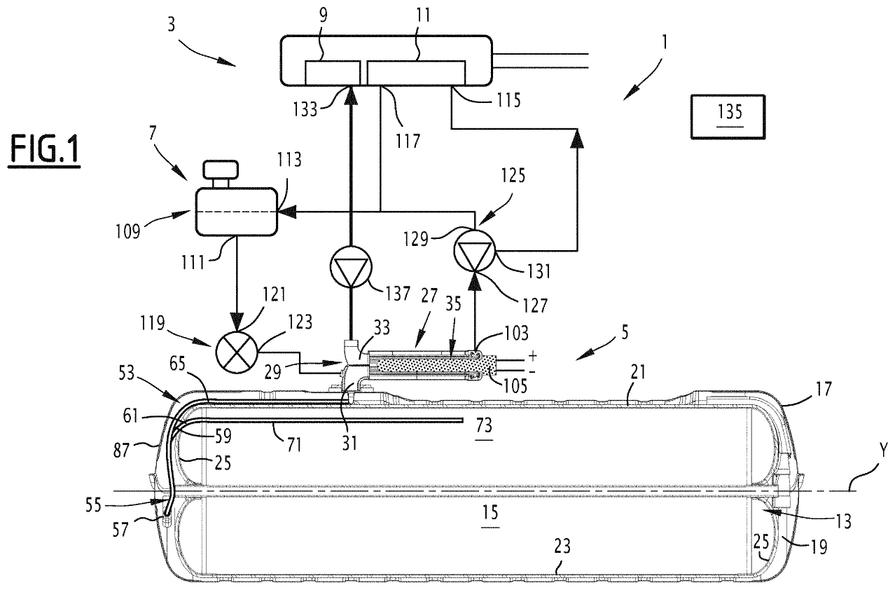

The assembly 1 shown in FIG. 1 comprises a fuel cell 3, a hydrogen storage and supply device 5, and a heat transfer fluid circuit 7.

This assembly 1 is typically provided to be installed on board a vehicle having an electric propulsion motor, for example a motor vehicle, a train, a boat or any other vehicle. The motor vehicle is, for example, a car, a utility vehicle, a truck, etc.

The fuel cell 3 is configured to produce electricity, and to supply the electric propulsion motor.

The fuel cell 3 comprises an anode gas circuit 9 and a cell cooling circuit 11. The fuel cell 3 further comprises a cathode gas circuit, not shown.

The anode gas circuit 9 is supplied with hydrogen by the storage and supply device 5.

The cathode gas circuit is supplied with an oxidizing gas, this oxidizing gas typically being oxygen.

The fuel cell 3 comprises a plurality of cells, each equipped with an anode and a cathode. The anode gas circuit 9 supplied with hydrogen to the anode, the hydrogen being broken down at the anode into H⁺ protons. The H⁺ protons migrate through a barrier toward the cathode, and combine at the cathode with the oxygen circulating in the cathode gas circuit to produce water vapor. The cell cooling circuit 11 is arranged to cool the cells of the fuel cell 3.

Chemical reactions, of the redox type, occurring at the anode and at the cathode create an electric current.

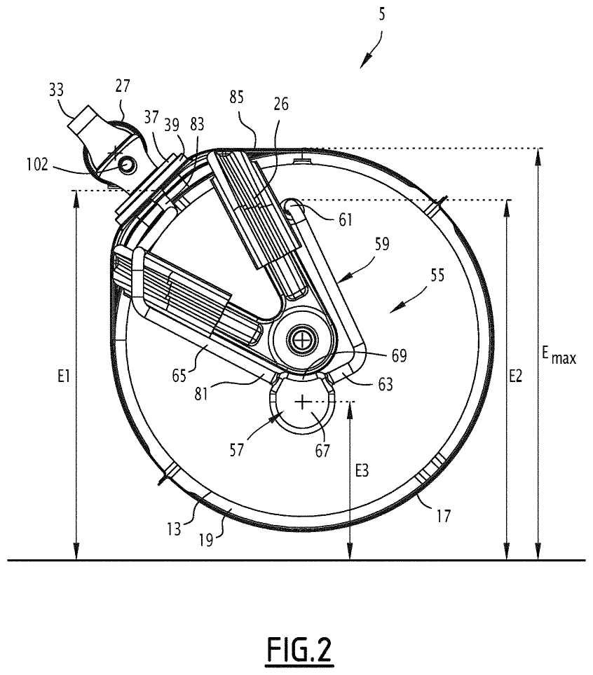

As can be seen in FIGS. 1 and 2, the hydrogen storage and supply device 5 comprises an internal reservoir 13 interiorly delimiting a storage volume 15 intended to store liquid hydrogen. The storage and supply device 5 further comprises an external reservoir 17, inside which the internal reservoir 13 is arranged, as well as an intermediate space 19 separating the internal reservoir 13 from the external reservoir 17.

Thermal insulation 21 (FIG. 1) is interposed between the internal reservoir 13 and the external reservoir 17.

The internal reservoir 13 is typically a horizontal axis.

It comprises a cylindrical shroud 23 and two bottoms 25 closing the two ends of the cylindrical shroud 23.

The cylindrical shroud 23 has its horizontal central axis Y.

The external reservoir 17 has a shape similar to that of the internal reservoir, with a cylindrical shroud having the axis Y as the central axis, closed by two curved bottoms at its ends.

The external reservoir 17 is without direct contact with the internal reservoir 13. This means that the internal reservoir 13 and the external reservoir 17 are mechanically in contact with one another via suspensions 26, the thermal insulation 21 not being in direct contact with the external reservoir 17. The suspensions 26 are arranged to minimize heat transfer from the external reservoir 17 to the internal reservoir 13.

The thermal insulation 21 comprises a plurality of metal sheets superimposed on one another, with interposition of fiber layers. This thermal insulation 21 is placed on the external surface of the internal reservoir 13.

Furthermore, the intermediate space 19 is kept under a high vacuum, so as to greatly limit the heat transfer by convection from the external reservoir 17 to the internal reservoir 13.

The storage and supply device 5 further comprises a heat exchanger 27, comprising a hydrogen circulation side 29 provided with a hydrogen inlet 31 and a hydrogen outlet 33, and a heat transfer fluid circulation side 35.

The heat exchanger 27 comprises a fastening member 37 arranged around the hydrogen inlet 31 (FIG. 2).

This fastening member 37 is typically a flange.

The storage and supply device 5 comprises a complementary fastening member 39 secured to the external reservoir 17 and attached to the fastening member 37.

The complementary fastening member 39 is typically a flange. The fastening member 37 and the complementary fastening member 39 are attached to each other by any suitable method or mechanism, for example by welding or by removable members such as screws.

The fastening member 37 and the complementary fastening member 39 have respective internal orifices, aligned with each other.

In the example shown, the hydrogen inlet 31 is tubular in shape and is engaged in the internal orifices of the fastening member 37 and the complementary fastening member 39.

The complementary fastening member 39 is attached to the external surface of the external reservoir 17, by any suitable method or mechanism.

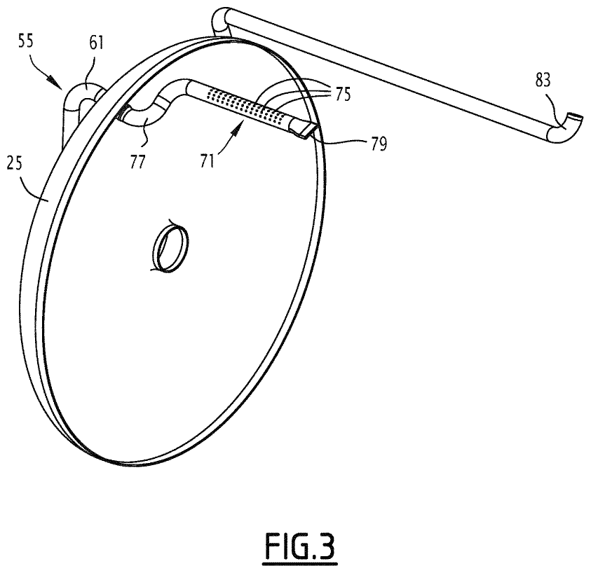

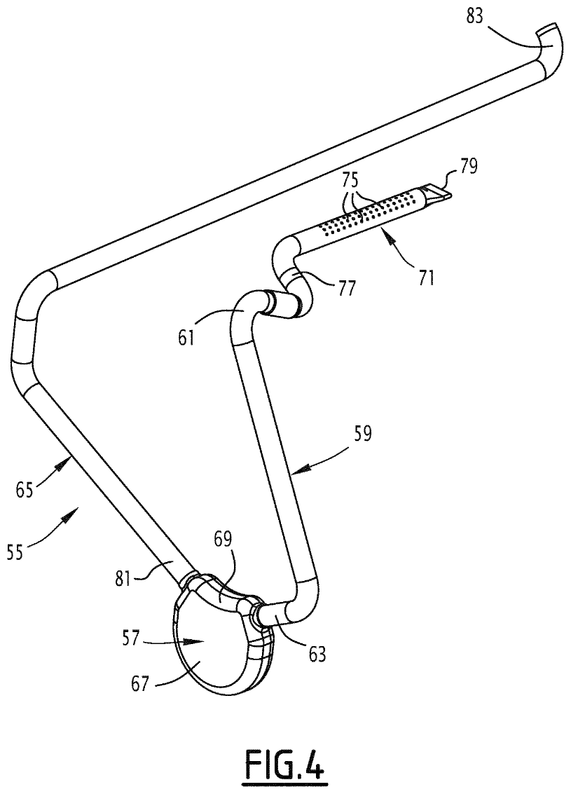

The storage and supply device 5 further comprises a conduit 53 for supplying the heat exchanger 27 with hydrogen, shown in FIGS. 2 to 4.

The supply conduit 53 comprises an external conduit 55, housed in the intermediate space 19.

The external conduit 55 has no contact with the external reservoir 17.

This means that there is no direct mechanical contact between the external reservoir 17 and the external conduit 55.

The external conduit 55 comprises:
an intermediate volume 57;
an upstream section 59 having an upstream upper end 61 passing through the internal reservoir 13 and fluidically connected to the storage volume 15, and an upstream lower end 63 connected to the intermediate volume 57;
a downstream section 65 connected to the intermediate volume 57 and having a downstream upper end 83 connected to the hydrogen inlet 31.

The downstream upper end 83 is located at a first elevation E1 (FIG. 2). The upstream upper end 61 being located at a second elevation E2. The intermediate volume 57 is located at a third elevation E3, less than the first and second elevations E1 and E2.

The elevations E1, E2 and E3 are taken relative to the same reference level, for example the level of a floor under the external reservoir 17. They are taken in the vertical direction, which is typically the direction normal to the floor under the external reservoir 17.

In order to evaluate the elevations E1, E2 and E3, the geometric center of the downstream upper end 83, the upstream upper end 61 and the intermediate volume 57 are typically considered.

As can be seen in FIG. 2, the external conduit 55 therefore has a general V-shape pointing towards the floor, the intermediate volume 57 constituting the low point of the external conduit 55.

The liquid hydrogen entrained with the gaseous hydrogen in the external conduit 55 and deposited on the internal surface thereof will therefore run off and accumulate in the intermediate volume 57.

The difference between the second elevation E2 and the third elevation E3 is preferably greater than 150 mm. In the example shown, the intermediate volume 57 is located vertically below the central axis Y.

This contributes to obtaining that the droplets of liquid hydrogen entrained in the external conduit 55 are deposited on the inner surface of the external conduit 55 and are not entrained directly to the inlet of the heat exchanger 27. This also contributes to the fact that the path along the internal conduit 55 is sufficiently long to allow evaporation of the liquid droplets, and heating of the gaseous hydrogen.

The intermediate volume 57 is a liquid-gas separator.

The intermediate volume 57 comprises a lower part 67 for collecting the liquid and an upper part 69 to which the upstream section 59 and the downstream section 65 are connected.

The upper part 69 has a height less than 50% of the total height of the intermediate volume 57, preferably less than 33% of the total height, even more preferably less than 25% of the total height.

Thus, the lower part 67 preferably has a volume greater than the upper part 69.

The presence of the intermediate volume 57 is particularly advantageous when a plug of liquid coming from the storage volume 15 arrives in the external conduit 55. The intermediate volume 57 makes it possible to separate the liquid hydrogen from the gaseous hydrogen. The liquid accumulates in the lower part 67 of the intermediate volume 57 while the gas circulates directly from the upstream section 59 to the downstream section 65. The liquid remains in the intermediate volume 57 until evaporation.

The supply conduit 53 comprises an internal conduit 71, housed in a headspace 73 of the storage volume 15, and having orifices 75 opening into the storage volume 15.

The headspace 73 of the storage volume 15 corresponds to the upper zone of the volume of storage 15, which is not occupied by the liquid, and which therefore contains only gaseous hydrogen.

In other words, the internal conduit 71 is not embedded in the liquid hydrogen, but is located above the free surface of the volume of liquid hydrogen.

The internal conduit 71 is typically rectilinear.

It is advantageously substantially horizontal and extends over the majority of the length of the internal reservoir 13. Advantageously, the internal conduit 71 extends over the entire length of the internal reservoir 13. Alternatively, it is shorter.

The orifices 75 are distributed over the length of the internal conduit 71, typically regularly distributed.

Advantageously, they are turned upward, that is to say, on a side opposite the volume of liquid hydrogen.

The upstream upper end 61 of the upstream section 59 is fluidically connected to the internal conduit 71.

More specifically, the supply conduit 53 comprises a bent conduit 77, connecting the internal conduit 71 to the upstream upper end 61.

The bent conduit 77 is connected directly to one end of the internal conduit 71. The internal conduit 71 is closed at its end 79 opposite the bent conduit 77.

The end 79 is flattened and forms a fishtail.

The upstream upper end 61 passes through the internal reservoir 13. The passage through the internal reservoir 13 is carried out in a sealed manner.

The bent conduit 77 has a complex shape, determined by the respective positions of the upstream upper end 61 and of the internal conduit 71. In the example shown, it has a general S shape.

The downstream section 65 has a downstream lower end 81 directly connected to the intermediate volume 57. Its downstream upper end 83 is directly connected to the hydrogen inlet 31.

The downstream section 65 passes through the external reservoir 17 without direct contact. The downstream section 65 passes through an orifice of the external reservoir 17, placed in alignment with the internal orifice of the complementary fastening member 39.

The complementary fastening member 39 is located close to an apex of the external reservoir 17.

This means that, as can be seen in FIG. 2, the elevation E1 is between 80% and 100% of the elevation Emax of the apex 85 of the external reservoir 17.

The complementary fastening member 39 further is located angularly around the central axis Y of the internal reservoir 13 at a point forming, with the apex 85, an angle of between 0° and 60°, for example an angle of about 45°.

The external conduit 55 is arranged opposite one of the bottoms 25 of the internal reservoir 13.

More specifically, it is arranged between said bottom 25 and the bottom 87 of the external reservoir 17 located opposite the bottom 25 of the internal reservoir 13.

The external conduit 55 is thus heated by thermal radiation from the bottom 87 of the external reservoir 17.

The external conduit 55 is entirely arranged opposite the bottom 87, except the downstream upper end 83 of the downstream section 65 connected to the hydrogen inlet 31. This is arranged between the cylindrical shroud 23 of the internal reservoir 13 and the cylindrical shroud of the external reservoir 17.

The downstream section 65 has a complex shape, depending in particular on the position of the intermediate volume 57, and on the angular position of the complementary fastening member 39.

The hydrogen circulation side 29 of the heat exchanger 27 comprises a plurality of hydrogen circulation tubes 89 and a hydrogen distribution collector 90 in the tubes 89.

It also comprises an outlet collector 91, collecting the hydrogen exiting the tubes 89.

The hydrogen outlet 33 of the heat exchanger 27 opens into the outlet collector 91.

Each tube 89 has a general U shape with a first rectilinear tube part 92 opening into the distribution collector 90, a second straight tube part 93 opening into the outlet collector 91, and an intermediate part 94 of complex shape connecting the tube parts 92 and 93 together.

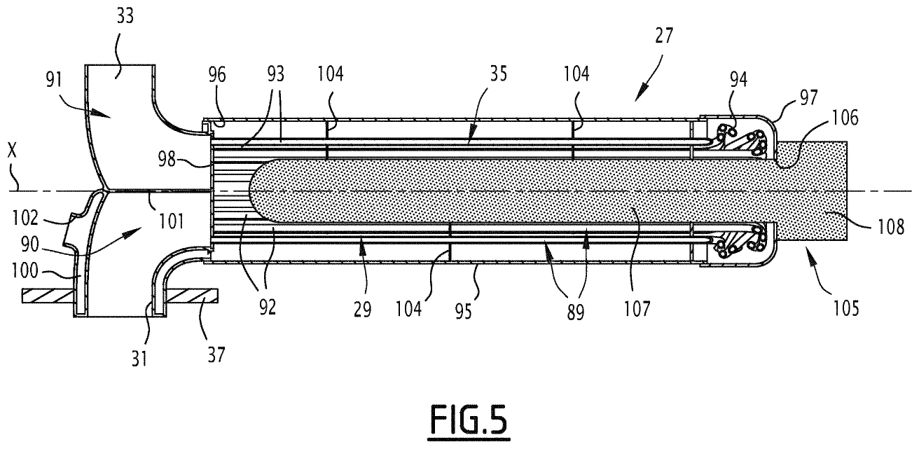

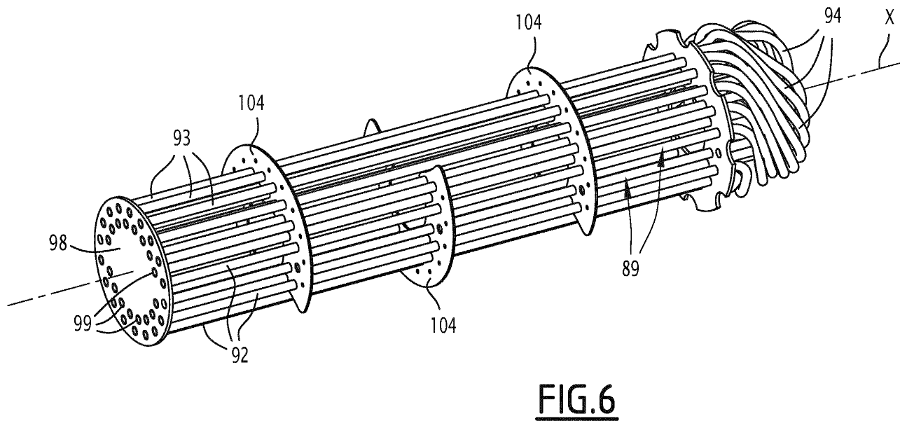

The tube parts 92, 93 of all the tubes 89 are parallel to the same direction X, shown in FIGS. 5 and 6.

The distribution and outlet collectors 90, 91 are located at a first end of the heat exchanger 27 in the direction X. The intermediate parts 94 of the various tubes 89 form a coil arranged at the second end of the heat exchanger 27, the second end being opposite to the distribution and outlet collectors 90, 91 in the direction X.

The heat transfer fluid circulation side 35 comprises a tubular body 95, elongated in the direction X. It internally delimits a circulation volume for the heat transfer fluid.

The body 95 has an opening 96 on the side of the distribution and outlet collectors 90, 91. It is closed by a bottom 97 on the side of the coil formed by the intermediate parts 94 of the tubes 89. The opening 96 is closed by a plate 98, pierced with holes 99 (FIG. 6). The ends of the tube portions 92, 93 are engaged and rigidly fixed each in one of the holes 99.

The ends of the tube portions 92 are gathered in an area of the plate 98 which delimits one side of the distribution collector 90.

Likewise, the ends of the tube portions 93 are gathered in an area of the plate 98 which delimits one side of the outlet collector 91.

The tubes 89 are entirely housed in the body 95, without direct contact between the tubes 89 and the body 95 or the bottom 97.

The cooling fluid circulation side 35 comprises a double jacket 100 (FIG. 5), insulating the hydrogen distribution collector 90 from the external atmosphere.

In the example shown, the double jacket 100 delimits a tubular volume, one end of which constitutes the hydrogen inlet 31. Another end of the tubular volume is partially closed by the plate 98 and partially by a plate 101 separating the distribution and outlet collectors 90, 91 from each other. This tubular volume constitutes the distribution collector 90. The fastening member 37 is mounted around the double jacket 100.

The heat transfer fluid circulation side 35 has a heat transfer fluid inlet 102 and a heat transfer fluid outlet 103. The heat transfer fluid inlet 102 opens directly into the double jacket 100.

The double jacket 100 has a heat transfer fluid outlet 103 which opens into the internal volume of the body 95, at one end thereof.

The heat transfer fluid outlet 103 is provided at the end of the body 95 opposite the heat transfer fluid inlet 102 in the direction X. It is for example provided in the bottom 97.

The heat exchanger 27 further comprises a plurality of spacer plates 104, arranged inside the body 95 and distributed in the direction X. These spacer plates 104 are substantially perpendicular to the direction X. They have holes, receiving the tube parts 92, 93. They thus hold in position the tube portions 92, 93 relative to one another, and in position relative to the body 95.

Each spacer plate 104 only extends over part of the internal section of the body 95, such that the heat transfer fluid circulates in a baffle inside the body 95, from the double jacket 100 to the heat transfer fluid outlet 103.

The heat exchanger 27 further comprises an electrical heating member 105, arranged to electrically heat the hydrogen.

This electrical heating member 105 is of any suitable type. Typically, it heats resistively.

The electrical heating member 105 is engaged inside the body 95 through an orifice 106 provided in the bottom 97. It comprises an active heating part 107, releasing heat. This active heating part 107 extends along the central axis X of the heat exchanger 27, from the orifice 106, over the majority of the length of the body 95.

The electrical heating member 105 also comprises a connecting part 108, located outside the body 95. The active heating part 107 is electrically connected to a current source, which may be the fuel cell 3, through the connecting part 108.

The tube parts 92, 93 are arranged in a circle around the active heating part 107. The coil formed by the intermediate parts 94 is arranged in a ring around the active heating part 107.

The heat transfer fluid is typically water, preferably comprising an antifreeze.

The heat transfer fluid circuit 7, as shown in FIG. 1, comprises an expansion vessel 109, having a vessel outlet 111 and a vessel inlet 113.

The cell cooling circuit 11 has a cooling inlet 115 and a cooling outlet 117. The vessel inlet 113 is fluidically connected to the cooling outlet 117.

The heat transfer fluid circuit 7 further comprises a heat transfer fluid circulation member 119, having a suction 121 fluidically connected to the vessel outlet 111, and a discharge 123 fluidically connected to the heat transfer fluid inlet 102 on the heat transfer fluid circulation side 35 of the heat exchanger 27.

The heat transfer fluid circulation member 119 is typically a pump, of any suitable type.

The heat transfer fluid circuit 7 further comprises an orientation member 125 having an inlet 127 fluidically connected to the heat transfer fluid outlet 103 on the heat transfer fluid circulation side 35 of the heat exchanger 27. The orientation member 125 further comprises a first outlet 129 fluidically connected to the vessel inlet 113, and a second outlet 131 fluidically connected to the cooling inlet 115 of the cell cooling circuit 11.

The orientation member 125 is configured to fluidically connect the inlet 127 selectively to the first outlet 129 or to the second outlet 131.

The orientation member 125 is typically a three-way valve.

Furthermore, as shown in FIG. 1, the hydrogen outlet 33 on the hydrogen circulation side 29 of the heat exchanger 27 is fluidically connected to the anode gas inlet 133 of the anode gas circuit 9 of the fuel cell 3. This anode gas circuit 9 has an anode gas outlet not shown. The assembly 1 also comprises a controller 135. The controller 135 drives at least the electrical heating member 105 and the orientation member 125, as a function of information received from the on-board computer(s) of the vehicle.

The controller 135 is in particular configured to selectively:
Turn on the electrical heating member 105 and fluidically connect the inlet 127 of the orientation member to the first outlet 129; or
Turn off the electrical heating member 105 and fluidically connect the inlet 127 of the orientation member 125 to the second outlet 131.

A valve 137 is inserted between the hydrogen outlet 33 and the anode gas inlet 133.

The operation of the assembly 1 will now be described.

When the fuel cell 3 is operating normally, the hydrogen gas filling the headspace 73 of the internal reservoir 13 penetrates into the internal conduit 71 through the orifices 75.

The hydrogen pressure in the interior reservoir 13 is adjusted with a heating member (not shown) configured to heat the liquid hydrogen stored in the internal reservoir 13.

The gaseous hydrogen flows from the internal conduit 71 to the bent conduit 77, then through the external conduit 55. It is heated by passing through the external conduit 55, by thermal radiation from the bottom 87 of the external reservoir 17. The droplets of liquid hydrogen optionally entrained with the gaseous hydrogen are evaporated during the passage through the external conduit 55.

If a large quantity of liquid is driven in the internal conduit 71 and constitutes a plug moving along the external conduit 55, the movement of this plug is stopped when it reaches the intermediate volume 57. The liquid is collected in the lower part 67 of the intermediate volume 57, the gas propelling the liquid plug directly passing through the intermediate volume, from the upstream section 59 to the downstream section 65. The liquid collected in the lower part 67 of the intermediate volume 57 is heated by thermal radiation and vaporizes.

The hydrogen gas exits the supply conduit 53 and penetrates into the heat exchanger 27 through the hydrogen inlet port 31.

It penetrates directly into the hydrogen distribution collector 90. From this collector, it is distributed in the hydrogen circulation tubes 89. It travels through the tubes 89 to the outlet collector 91. At the outlet of the tubes 89, the hydrogen gas is at a temperature close to 0° C. (in order to avoid forming a block of ice), the temperature possibly and transiently being able to reach a minimum of about −40° C.

The hydrogen, in its path from the storage volume 15 to the hydrogen outlet 33, is never in contact with a surface immersed in the ambient air. Indeed, the external conduit 55 is isolated from the ambient air by the external reservoir 17. The hydrogen distribution collector 90 is isolated from the ambient air by the double jacket 100. The tubes 89 are isolated from the ambient air by virtue of the cooling liquid contained in the body 95.

Thus, any risk of liquefaction of the air in contact with the hydrogen is eliminated.

The heat transfer fluid is discharged by the circulation member 119 to the heat transfer fluid inlet 102. It flows into the double jacket 100 and then into the body 95 to the heat transfer fluid outlet 103. It transfers its heat to the gaseous hydrogen circulating in the tubes 89.

When the fuel cell 3 is operating normally, the controller 135 keeps the electrical heating member 105 turned off and controls the orientation member 125 so as to fluidically connect the inlet 127 to the second outlet 131. The heat transfer fluid leaving the heat exchanger 27 thus circulates to the cooling inlet 115 of the cell cooling circuit 11.

The heat transfer fluid then circulates inside the fuel cell 3 to the cooling outlet 117. It is heated by the heat generated by the fuel cell 3.

From the cooling outlet 117, it circulates to the inlet 113 of the expansion vessel 109, then from the outlet 111 of the expansion vessel 109 to the suction 121 of the heat transfer fluid circulation member 119.

When the vehicle is started, more specifically when the fuel cell 3 is started, this fuel cell 3 cannot supply the heat transfer fluid circuit 7 with a sufficient amount of heat to heat the hydrogen.

In this case, the controller 135 activates the electrical heating member 105, and controls the orientation member 125 so as to fluidically connect the inlet 127 to the first outlet 129. The heat transfer fluid leaving the heat exchanger 27 via the heat transfer fluid outlet 103 is oriented directly by the orientation member 125 to the vessel inlet 113, without going through the fuel cell 3.

It then circulates directly from the vessel outlet 111 to the suction of the circulation member 119 and then the heat transfer fluid inlet 102.

The hydrogen circulating inside the heat exchanger 27 is heated by the heat assigned by the electrical heating member 105.

The controller 135 controls the return to normal operation described above for example after a certain duration of operation of the fuel cell 3, or when the fuel cell 3 has reached a sufficient temperature, or on the basis of any other suitable criterion.

The hydrogen storage and supply device 5 and the assembly 1 described above has multiple advantages.

As indicated above, the very cold hydrogen coming from the storage volume is never in contact with a wall immersed in the ambient air, such that the risks of liquefaction of the ambient air are eliminated.

The existence of an intermediate volume acting as a gas-liquid separator in the external conduit helps prevent priming, that is helps prevent the arrival of liquid hydrogen at the inlet of the exchanger. This exchanger operates only in the gas phase, which considerably simplifies the design of the exchanger and its operation. A few small droplets of hydrogen can be introduced therein, but this exchanger is not an evaporator, that is it is not sized to fully evaporate a stream consisting of liquid hydrogen.

The intermediate volume makes it possible to avoid running as a heat pipe. More specifically, all the upstream and downstream sections and the intermediate volume prohibit the typical operation of a heat pipe. A conventional heat pipe contains a fluid under vacuum, this fluid being both in vapor and liquid form. For a tube to function as a heat pipe, the fluid must be in contact with a cold source, sufficiently cold for the fluid to be in liquid form at the current pressure, and the other side must be sufficiently cold for it to be liquid at this pressure. Between the two sides, a very strong exchange is created that mainly depends on the depths of these sources. The steam goes from the cold side through the center of the tube and condenses in contact with the cold side. It amounts to supplying the hot part by running along the wall of the tube. Having a vertical tube and a volume with a change in cross-section makes it possible to avoid this phenomenon which would pump the cold of the reservoir.

Furthermore, the conduit for supplying the heat exchanger with hydrogen, and the heat exchanger itself, contain a known volume of gaseous hydrogen, which can be considered as a buffer volume. When the fuel cell is off, there is no longer any hydrogen consumption. It is then necessary to ensure that, as long as it is off, there is no exchange between the gaseous hydrogen and the liquid hydrogen, which could freeze the exchanger and liquefy the ambient air. The existence of the buffer volume makes it possible to avoid such an effect. It is thus possible to avoid placing a cryogenic valve, which is extremely expensive to manufacture, upstream of the heat exchanger. The valve 137 isolating the hydrogen outlet from the heat exchanger of the anode gas inlet is placed after the heat exchanger, in the normal temperature zone. It is therefore much less expensive than a cryogenic valve.

Indeed, when turned off and in the absence of a heat pipe effect, the hydrogen gas is found in the heat exchanger and also in a part of the downstream section preceding it. Thus, there will be no gas movement. The hot gases are at the highest point and are separated by gravity from the cold gases. The low intrinsic conductivity of the gases also contributes to this result. In other words, the gases occupying the two zones do not have a reason to mix, and the thermal path along the tubes is sufficiently long to prevent the thermal contact causing the reheating water to be dissipated.

The fact that the external conduit is V-shaped, with a low point, contributes to limiting the arrival of liquid hydrogen at the inlet of the heat exchanger.

The fact that the internal conduit is housed in the headspace of the storage volume contributes to limiting the risk of liquid being entrained toward the heat exchanger.

The fact that the internal conduit is substantially horizontal and extends over the majority of the length of the internal reservoir also makes it possible to avoid the formation of a plug of liquid inside the supply conduit, in particular during the movements of the liquid inside the storage volume due to braking or accelerations.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A hydrogen storage and supply device comprising:
an internal reservoir which internally delimits a storage volume configured to store liquid hydrogen;
an external reservoir inside which the internal reservoir is arranged, wherein an intermediate space separates the internal reservoir from the external reservoir;
thermal insulation interposed between the internal reservoir and the external reservoir;
a heat exchanger, comprising a hydrogen circulation side provided with a hydrogen inlet and a hydrogen outlet, and a circulation side of a heat transfer fluid;
a conduit that supplies the heat exchanger with hydrogen and having an external conduit received in the intermediate space, said external conduit having:
an intermediate volume;
an upstream section having an upstream upper end passing through the internal reservoir and fluidically connected to the storage volume, and an upstream lower end connected to the intermediate volume; and
a downstream section connected to the intermediate volume and having a downstream upper end connected to the hydrogen inlet; and
the downstream upper end being located at a first elevation, the upstream upper end being located at a second elevation, and the intermediate volume being located at a third elevation, lower than the first and second elevations.

2. The hydrogen storage and supply device according to claim 1, wherein the heat exchanger comprises a fastening member around the hydrogen inlet, the hydrogen storage and supply device comprising a complementary fastening member integral with the external reservoir and attached to the fastening member.

3. The hydrogen storage and supply device according to claim 2, wherein the complementary fastening member is located close to an apex of the external reservoir.

4. The hydrogen storage and supply device according to claim 1, wherein the intermediate volume is a liquid-gas separator.

5. The hydrogen storage and supply device according to claim 4, wherein the intermediate volume comprises a lower part to collect liquid and an upper part to which the upstream section and the downstream section are connected.

6. The hydrogen storage and supply device according to claim 1, wherein the internal reservoir comprises a cylindrical shroud with a horizontal axis and two bottoms closing two axial ends of the cylindrical shroud, the external conduit being arranged opposite one of the two bottoms.

7. The hydrogen storage and supply device according to claim 1, wherein the conduit comprises an internal conduit, housed in a headspace of the storage volume, and having orifices opening into the storage volume, the upstream upper end of the upstream section being fluidically connected to the internal conduit.

8. The hydrogen storage and supply device according to claim 1, wherein a difference between the second elevation and the third elevation is greater than 150 mm.

9. The hydrogen storage and supply device according to claim 1, wherein the hydrogen circulation side comprises a plurality of hydrogen circulation tubes and a collector that distributes the hydrogen in the plurality of hydrogen circulation tubes into which the hydrogen inlet opens, the circulation side of the heat transfer fluid comprising a double jacket insulating the collector from an external atmosphere.

10. An assembly comprising:
a fuel cell having an anode gas circuit provided with an anode gas inlet and a cell cooling circuit having a cooling inlet and a cooling outlet;
a hydrogen storage and supply device according to claim 1, the hydrogen outlet on the hydrogen circulation side of the heat exchanger being fluidically connected to the anode gas inlet; and
a heat transfer fluid circuit comprising:
an expansion vessel having a vessel outlet and a vessel inlet fluidically connected to the cooling outlet;
a heat transfer fluid circulation member having a suction fluidically connected to the vessel outlet, and a discharge fluidically connected to a heat transfer fluid inlet on the circulation side of the heat exchanger; and
an orientation member having an inlet fluidically connected to a heat transfer fluid outlet on the circulation side of the heat exchanger, a first outlet fluidically connected to the vessel inlet and a second outlet fluidically connected to the cooling inlet of the cell cooling circuit, the orientation member being configured to fluidically connect the inlet selectively to the first outlet or the second outlet.

11. The assembly according to claim 10, wherein the heat exchanger comprises an electrical heating member arranged to electrically heat the hydrogen, the assembly comprising a controller configured to selectively:
turn on the electrical heating member and fluidically connect the inlet of the orientation member to the first outlet; or
turn off the electrical heating member and fluidically connect the inlet of the orientation member to the second outlet.

12. The hydrogen storage and supply device according to claim 5, wherein the lower part has a volume greater than the upper part.
